(19) United States
(12) Patent Application Publication
(10) Pub. No.: US 2008/0281639 A1
(43) Pub. Date: Nov. 13, 2008

(54) REAL-TIME EVIDENCE- AND GUIDELINE-BASED RECOMMENDATION METHOD AND SYSTEM FOR PATIENT CARE

(76) Inventors: Peter C. Quinn, Fairfield, CT (US); Beverly C. Walters, Providence, RI (US)

Correspondence Address: SCHIFF HARDIN, LLP;PATENT DEPARTMENT, 6600 SEARS TOWER, CHICAGO, IL, 60606-6473, US

(21) Appl. No.: 12/117,312

(22) Filed: May 8, 2008

Related U.S. Application Data
(60) Provisional application No. 60/916,836, filed on May 9, 2007.

(51) Int. Cl. G06Q 50/00

(52) U.S. Cl. 705/3

(57) ABSTRACT

A system and method for providing feedback to a patient caregiver is provided that receives information on a periodic basis, such as every hospital shift, performs a parametric analysis on the treatment given with known standards that are stored in a database, and generates a report that identifies whether the care that is being given is consistent or inconsistent with the guidelines. A source of the guidelines is provided so that a physician can consult with the source information, if desired. The patient data may be entered in by the caregiver, and the feedback may be provided to the caregiver, via a portable device, such as a mobile telephone or PDA (personal digital assistant).

### CROSS-REFERENCE TO RELATED APPLICATION

This application claims the benefit of U.S. Provisional Patent Application Ser. No. 60/916,836, filed 9 May 2007.

### BACKGROUND

The present invention relates generally to a method and system for providing medical care to a patient, and in particular to a method and system for comparing patient care information to guidelines for patient care.

The present invention provides a method and system for implementing the method that delivers the science of evidence-based medicine directly to the point-of-care. The system and method advantageously provide: increased compliance with evidence-based guidelines with the expectation of dramatic improvement in patient outcomes, and a reduction in the cost of care for the payers, including government.

Evidence-based care is the practice of medicine guided by the strength of the best available clinical research for a specific diagnosed condition. Because of the very powerful effects evidence-based medicine has on patient outcome and cost, it is considered to be a “best practice.” Yet, the adaptation of evidence-based medicine for the care of patients has been astonishingly slow.

### SUMMARY

The present invention provides a sophisticated interactive system to assist caregivers in delivering the most current evidence-based medical care as represented by nationally and internationally vetted evidence based treatment recommendations. This is done in a highly efficient manner, in real time, and interacts with caregivers right at the point of care. The system and method are unique in their character, approach, and operational details and thus provide enlightened health care reform: where the latest evidence-based medical care is rendered, the patient achieves the best recovery possible, and less money is spent. This also minimizes variation in the care of patients across the country, and internationally.

The present invention is described according to an exemplary embodiment related to the treatment of severe traumatic brain injury (TBI), but is applicable to cover a broad range of patients, including severely ill patients, and fields of medicine, ranging from, by way of example, neurology, cardiovascular, OB-GYN, orthopedics to oncology. Existing protocols for diagnosing, treating, and managing severe traumatic brain injury are known from, e.g., Bullock, Ross M. M.D., et al., “Guidelines for the Management of Severe Traumatic Brain Injury”, Journal of Neurotrauma, Vol. 17, No. 6/7, June/July 2000, herein incorporated by reference.

All available evidence in the medical literature indicates that following evidence-based guidelines in the treatment of TBI patients dramatically improves patient outcomes: reducing mortality by 20-50% and improving functional outcome by 50%, while reducing acute care costs by 20%.

Improving functional outcomes also reduces long-term care costs substantially. This is especially significant for state Departments of Health and the federal Department of Health and Human Services, since the majority of TBI patients in long term care are paid for from the Medicaid program.

Accordingly, a method is provided for giving continuous patient care, comprising repeated steps of: entering guidelines and associated parameters in an evidence-based guidelines database that comprise treatment recommendations and guideline source of origin information; entering, by a caregiver on a caregiver device at a caregiver facility, patient status and treatment information on a periodic basis; securely transmitting the entered patient information to a secure assessment system; immediately after receipt of the patient information, performing the following by the assessment system: retrieving relevant guidelines from the guideline database; comparing the retrieved guidelines with the patient information using a parametric comparison; generating a patient customized assessment report by the assessment system that includes an assessment of the patient treatment information; and securely transmitting the patient report to the caregiver.

Further, a system is provided that permits continuous patient care, comprising: an evidence-based guidelines database that comprises guidelines, treatment recommendations, and guideline source of origin information; a caregiver device via which a caregiver enters patient states and treatment information on a periodic basis, the caregiver device comprising a secure communications link; and an assessment system comprising a secure communications link that securely receives data that includes the patient status and treatment information from the caregiver device communications link, the assessment system having a communications link to the evidence-based guidelines database via which guidelines are accessed and then compared to the patient status and treatment information using a parametric comparison, the assessment system having a report generator that generates a patient customized assessment report, the assessment system transmitting the report over the secure communications link to the caregiver device.

### DESCRIPTION OF THE DRAWINGS

The invention is explained in more detail with reference to various preferred embodiments illustrated in the drawing figures and described below.

FIG. 1A is a block diagram illustrating a basic overall flow of an embodiment of the process;

FIG. 1B is a block diagram illustrating a more detailed flow of an embodiment of the process;

FIGS. 2A-C are exemplary flow diagrams illustrating specific procedures that may be utilized; and

FIGS. 3A, B are exemplary report outputs produced by the system.

### DETAILED DESCRIPTION OF THE PREFERRED EMBODIMENTS

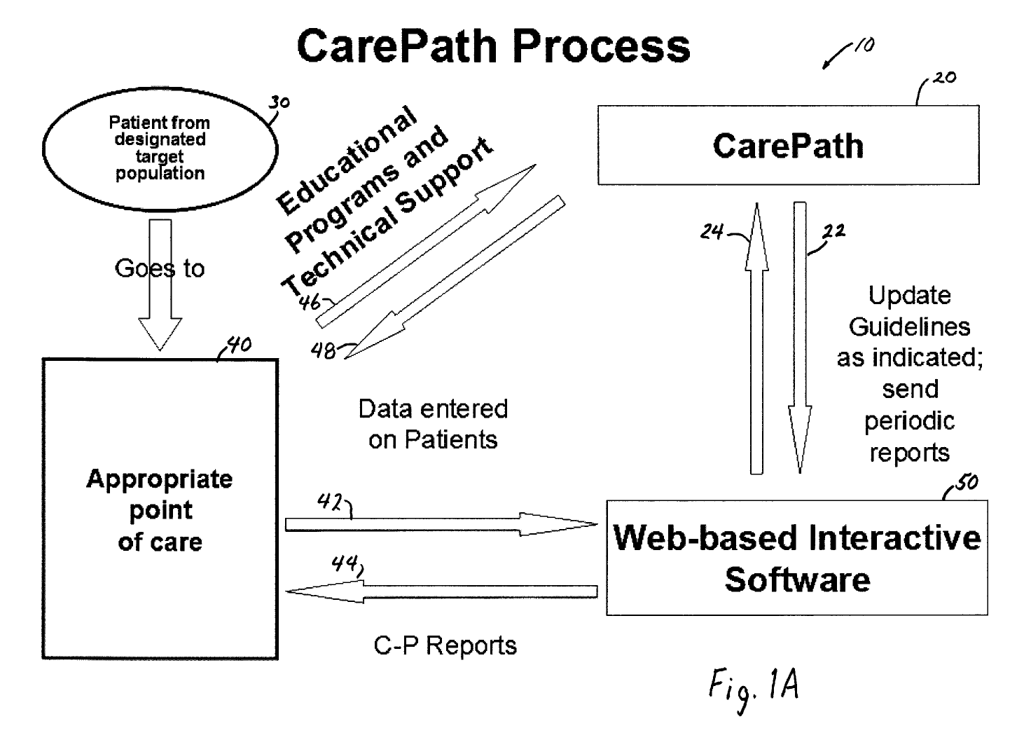

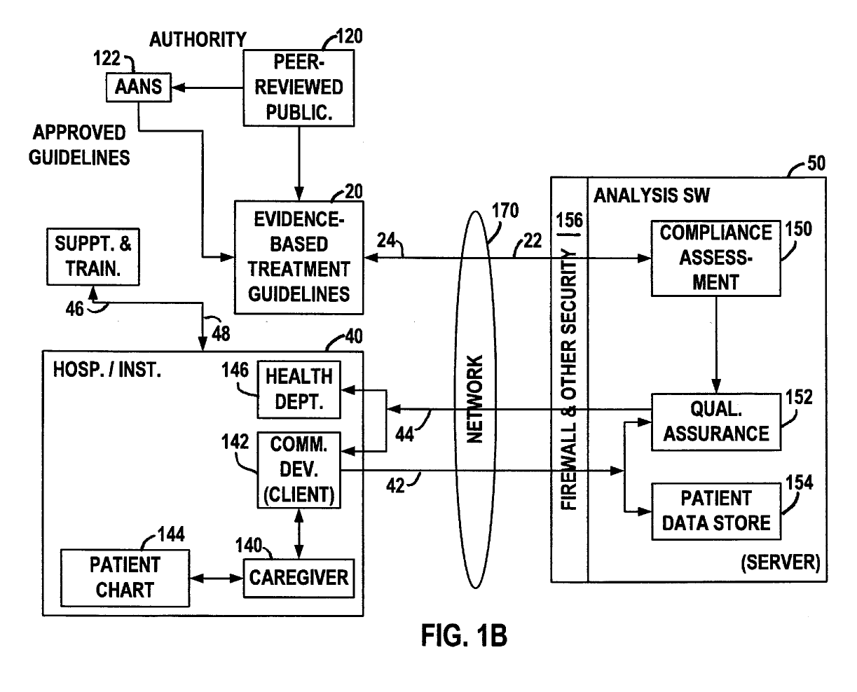

FIG. 1A illustrates a broad overview of the process 10. Information on recognized guidelines is established in a guideline database 20 (shown here under the name Carepath) and may be updated as the guidelines change over time. A patient 30 requiring treatment goes to a point of care 40 to begin treatment. This point of care can be an acute care facility, a case manager office, a rehabilitation facility, etc. When the patient arrives, he or she is registered in the system. Personnel may securely access the system using some form authentication for ensuring identification and authorization. This may be as simple as a username and password, or can implement any other form of recognitions, such as biometrics, etc.

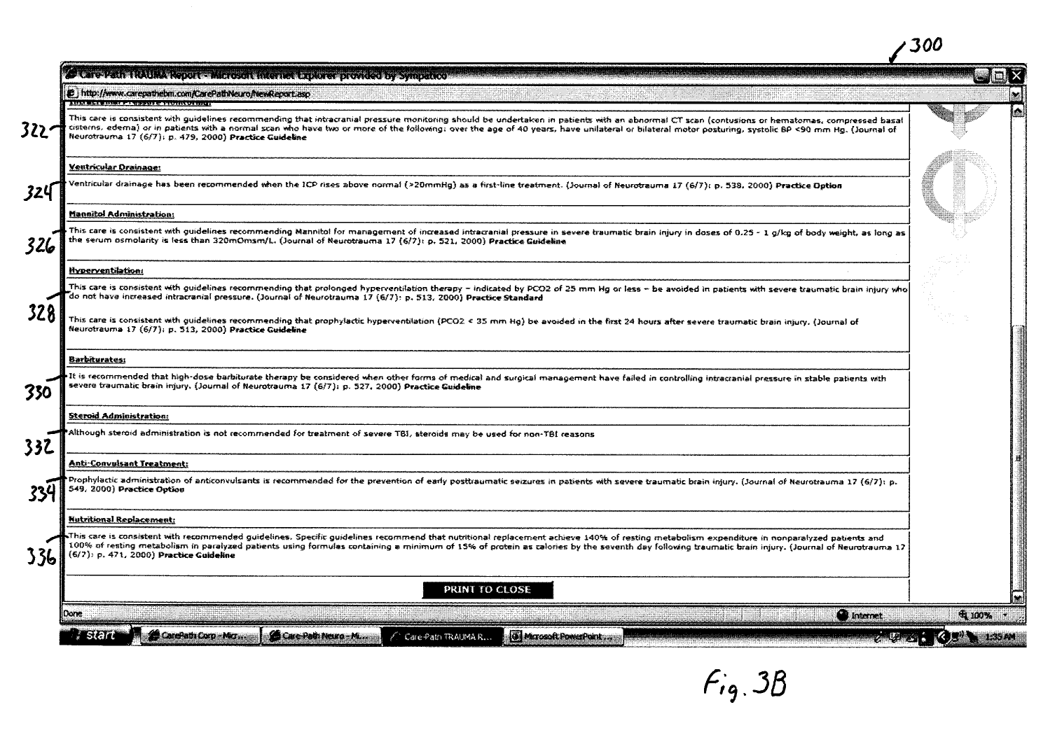

Patient data 42 is frequently, and throughout treatment, provided to an analysis system 50 that contains software routines for analyzing the treatment given to the patient 30, based on the patient data 42 received. The software routines access guideline data 22 in order to determine whether the patient care data conforms to the guidelines or is inconsistent with the guidelines. Feedback 44 related to the care of the patient 30 may then be provided to the point of care 40. At the close of data input, the report screens illustrated in FIGS. 3A, B are exemplary of those that may appear and can be printed to be used either as QA documents, or as an integral part of the patient's medical record, depending upon the client's desires and needs.

The guideline database 20 can also be used to provide general guideline information 48 to the point of care 40, via, e.g., educational programs and the like. The guideline database 20 can be updated based on information received 46 from the point of care 40, from information received from the analysis system 50, and from standards committees and the like. Furthermore, it is possible to feed back information 24 related to patient care given to the guideline database 20

Various aspects of the system and method are described in further detail below, and with reference to FIG. 1B. As noted above, authoritative treatment guidelines are relied upon as the basis for assessing the treatment of a patient. The guidelines are preferably determined from peer-reviewed publications 120. Where such guidelines are unavailable, other published guidelines may be utilized as well, although the origins and limitations of such guidelines should be clearly provided to the medical personnel. The guidelines would be approved by an authoritative body, such as the American Association of Neurological Surgeons (AANS) 122 to ensure that the guidelines meet accepted criteria for treatment.

The evidence-based treatment guidelines 20 are collected and stored in a database format in a highly secure commonly accessible location utilizing standard database software and accessed using SQL. Known database technologies may be utilized for organizing this information, and known networked client-server architectures may further be utilized in the system, with any scale processor ranging from PDA (personal digital assistant) devices and even cell phones for the communications device 142 on the low end to powerful high-end servers. Any standard user interface devices may be utilized as well to enter and receive relevant data.

Although the evidence-based treatment guidelines database 20 would have to contain some initial collection of guidelines prior to use, it is designed so that it can be updated and evolved as additional information becomes available and is entered.

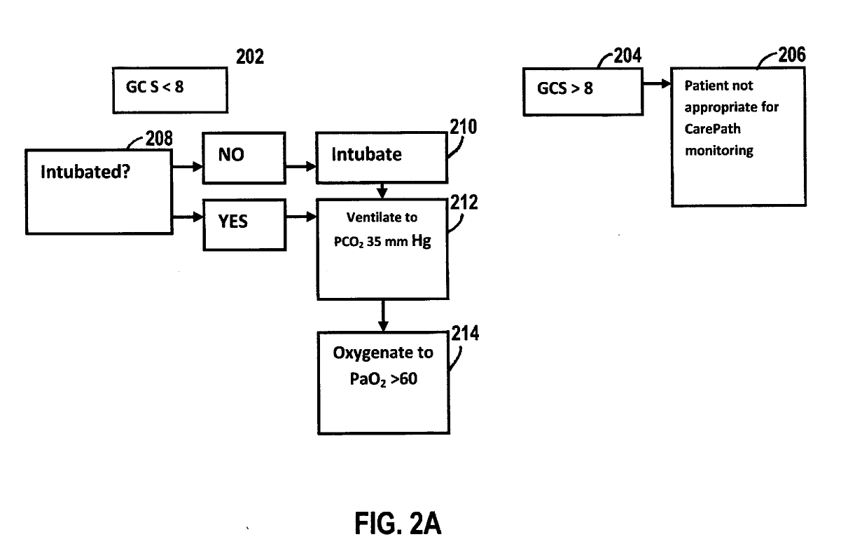

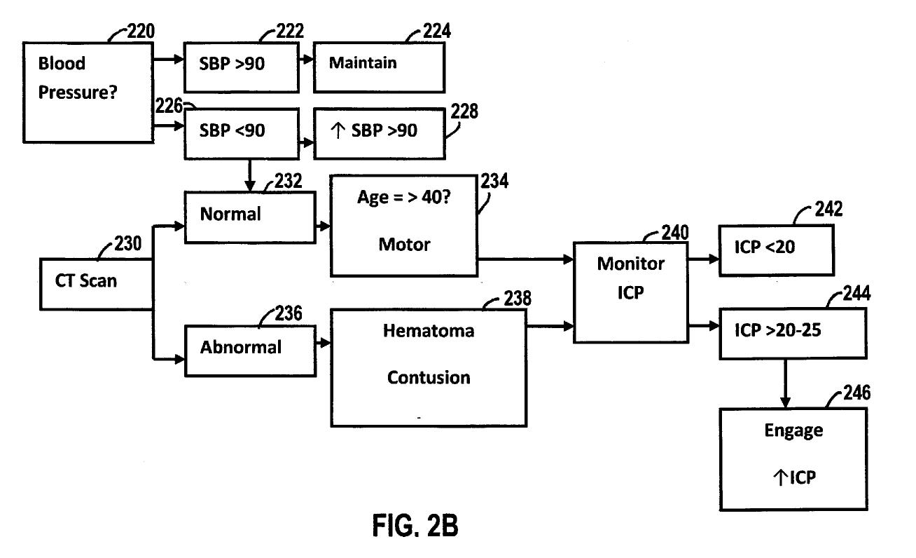

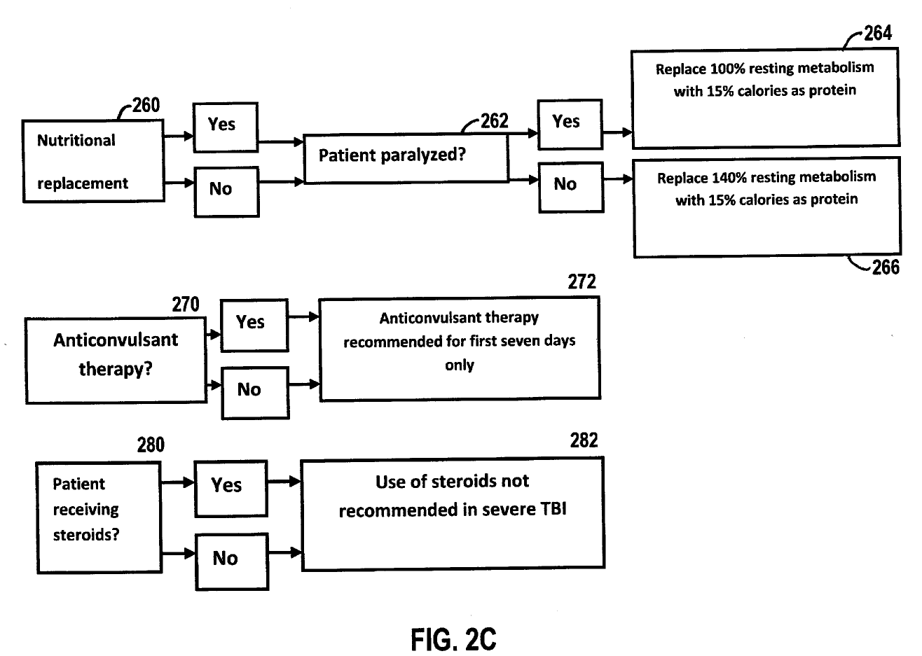

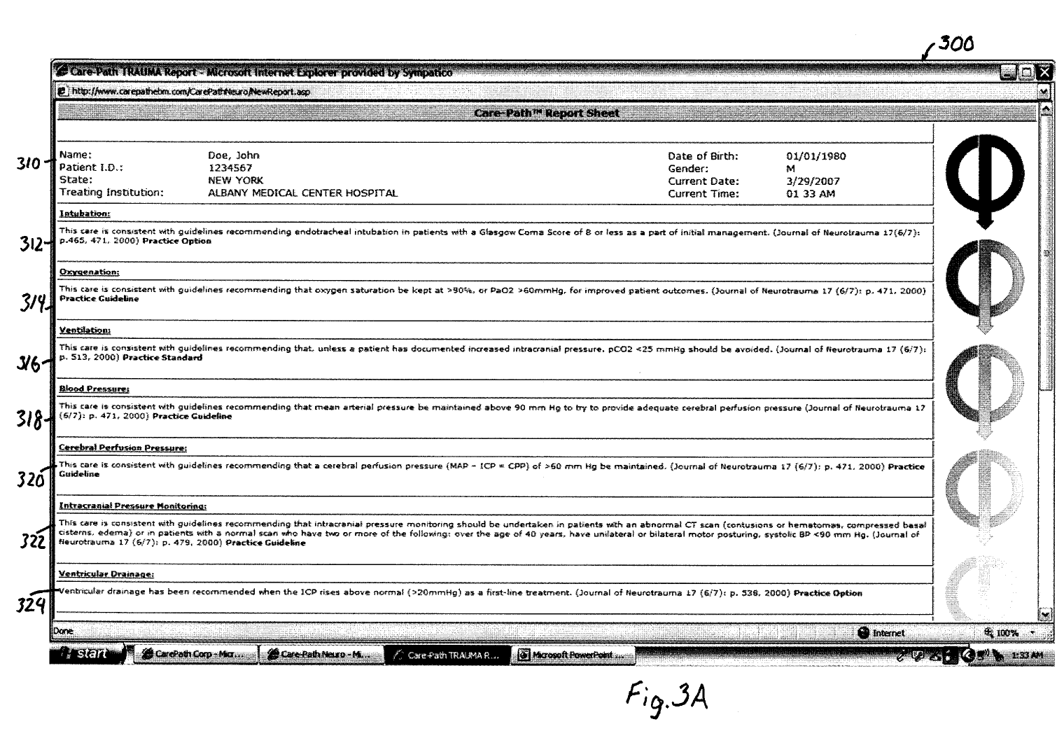

FIGS. 2A-2C illustrate an example of guidelines that could be stored in the database 20. In FIG. 2A a rule is present that if the Glasgow Coma Scale GCS is greater than 8 at reference 204, then the patient is not appropriate for monitoring using the system 206. However, if the GCS less than 8, then if the patient is not intubated 208, the patient should be intubated 210, and then treatment should proceed to ventilate the patient to a PCO₂ level of 35 mm Hg at reference 212, and then to oxygenate the patient to a PaO₂ level greater than 60 at reference 214.

In FIG. 2B, if the patient's systolic blood pressure 220 is greater than 90 at reference 222, then activities related to blood pressure are maintained 224. But if the patient's systolic blood pressure is less than 90 at reference 226, then appropriate activities are undertaken to raise the systolic blood pressure above 90 at reference 228. Turning to a computer tomograph (CT) scan 230, if the scan is normal 232 and the patient is 40 or older, then monitoring should be done (monitor) 234. However, if the CT Scan is abnormal 236, then this suggests a hematoma contusion 238 or other form of brain injury. In both cases, the intracranial pressure (ICP) is monitored 240. If the pressure is less than 20 at reference 242, then no further action needs to be taken, but if it is greater than 20 at reference 244, then activities should be undertaken to lower the increased pressure 246.

In FIG. 2C, whether the patient is receiving nutritional support 260 or not, the specifications of the recommended replacement will be given as a reminder 264 and 266, depending on whether the patient is paralyzed as determined at 262.

Returning to FIG. 1B, once an initial evidence-based treatment guidelines database 20 has been established, the system can be made operational to assess the care that is given to a patient.

A hospital or institution 40 receives a patient, such as one suffering from traumatic brain injury. In a traditional setting, a caregiver 140, such as doctors, nurses, and other support staff monitor the patient and chart the patient's progress and treatment on a patient chart 144. In the invention, specific data from the patient chart 144 is entered on a communications device 142 for transmission to the assessment system comprising the analysis software 50. The communications device 142 can be any device that has a user interface for entry of data, display feedback, and the capability to communicate with a remote system 50. In a preferred embodiment, the communications device is a wireless device, and may utilize standard wireless devices, such as a mobile telephone or PDA (personal digital assistant), although custom devices can also be used. However, a wired device can also be used, provided it is readily accessible to the caregiver 140 treating the patient.

In a preferred embodiment of the invention, caregivers 140 in the hospital 40 provide specific data from the patient's chart 144 at a minimum of every shift (eight to twelve hours), although this period can be adjusted as is appropriate for the condition being treated.

Once the patient data is entered on the communications device 142, it is sent to the analysis software 50 that, in an embodiment, is located on a secure remote system. When the system is remote, for security purposes (in order to protect patient privacy and confidentiality), the software product may reside on a server in a data vault. Ideally, there is a dedicated unshared connection to the Internet or other network 170 using both a hardware firewall and software firewall 156. For additional security, the data vault may be protected by a security guard, require access card entry, and/or demand biometric identification for entry. The system software 50 may utilize a server password and biometric ID, and provisions may be included to prohibit alteration remotely.

In one embodiment, the data is transmitted with 128-bit encryption, with all patient data stored in the database 154 with 4096-bit encryption. In this embodiment and with this level of security, this level of data protection and security is the highest known and recognized standard, exceeding all HIPAA standards.

The analysis software 50 may be implemented in a client-server architecture, and may, e.g., utilized web-based interactive software. Portions of the system, particularly the server according to a client-server architecture, may be accessed, as noted above, through the Internet or other known networking protocol in order to provide real-time interactivity with health care providers 140 at the point of patient care. Known communication protocols that include wireless, broadband, and telephone-based protocols may be utilized, depending on the availability of particular technologies.

The analysis software 50 receives the patient data 42 from the communications device 142 provided by the caregiver 140 and stores it in a patient data store 154 and passes the information on to the quality assurance software 152. The quality assurance software 152 processes the patient data 42 and performs a parametric analysis based on information related to a treatment type or condition (e.g., intubated, GCS, blood pressure, CT scan results, nutritional replacement, anticonvulsant therapy, steroids) along with any associated parameter values. The received treatment type, condition, and parameters are compared against those stored in the evidence-based treatment guidelines database 20 by a compliance assessment routine 150. The quality assurance routine 152 then produces a feedback report 44 that is sent to the communication device 142 and possibly a health department 146 of the hospital or institution 40. The health department 146 may also receive summary reports or reports with different information, such as statistical summaries, etc. than is directed to the caregiver 140. This may be done periodically or based on an event trigger or other specified criteria. It may also be done in response to a user inquiry.

The quality assurance report 44 (which is ideally provided at least two to three times per day for a minimum of, e.g., 20-30 times during the patient's ICU stay), is fed back to the caregiver 140 immediately after inputting patient data regarding the patient's condition and the current care. This quality assurance report 44 is very unique in both form and content. It has been specifically designed to focus the physician-in-charge on each critical guideline recommendation and clearly illustrate the status of their patient's care relative to the recommendations.

Further, the format of the report 44 encourages compliance by affirming care that is consistent with evidence-based guidelines 20 and supplying the recommendations and the source of the guidelines for them where it is not. The guideline source may be provided regardless so that a caregiver can confirm the propriety of the recommendation. Inventively, the present reporting system interacts in real time with health care professionals and is able to concurrently focus, inform, compare, modify as necessary and affirm guideline compliant physician behavior as our report does. This novel form of report serves as a way to affirm and guide evidence-based guideline compliant care. The interactive reporting system has broad applications to many other areas of medicine where evidence-based guidelines have been developed. It is only through the rigorous application of evidence-based treatment guidelines that the significantly positive effects will be fully realized for both patient and payer. An examples of such a report is provided in FIGS. 3A, 3B and are illustrated by way of example below.

FIGS. 3A, 3B show a report 300 as presented on a web browser. However, the report can be provided to the communications device 142 as discussed above, or could even be provided to a client device and then printed out in hardcopy for review by the caregiver 140. The report 300 illustrates exemplary fields for a TBI patient. The report has information that is specific to the patient 310, that can include any or all of the following fields as well as any other relevant fields: name, patient ID, address information, treating institution, date of birth, and gender, along with information related to the report itself, such as the date and time it was prepared. It could include additional information such as an identifier on the data set that was used to generate the report, or actual status information obtained from the data that triggered the report.

A field relating to intubation 312 provides the information:
This care is consistent with guidelines recommending endotracheal intubation in patients with a Glasgow Coma Score of 8 or less as a part of initial management. (Journal of Neurotrauma 17 (6/7); p. 465, 471, 2000) Practice Option
[Note: Practice Option, Guideline, or Standard (in one paradigm) or Level I, Level II, Level III, Level IV (in another paradigm) refers to the strength of the recommendation based upon the strength of the evidence, i.e., the robustness of the study that produced the evidence for the recommendation]

It can be seen that this field identifies that the particular treatment given to the patient was, in fact, consistent with the practice guidelines and provides a reference that serves as a basis for the guideline. The following fields in the report bear a similar format and are repeated below since the text in the figures may be too small to discern.

Oxygenation shown at reference 314:
This care is consistent with guidelines recommending that oxygen saturation be kept at >90%, or PaO>60 mm Hg, for improved patient outcomes. (Journal of Neurotrauma 17 (6/7); p. 471, 2000) Practice Guideline

Ventilation shown at reference 316:
This care is consistent with guidelines recommending that unless a patient has documented increased intracranial pressure, PCO2<25 mmHg should be avoided. (Journal of Neurotrauma 17 (6/7); p. 513, 2000) Practice Standard

Blood Pressure shown at reference 318:
This care is consistent with guidelines recommending that mean arterial pressure be maintained above 90 mm HG to try to provide adequate cerebral perfusion pressure. (Journal of Neurotrauma 17 (6/7); p. 471, 2000) Practice Guideline

Cerebral Perfusion Pressure shown at reference 320:
This care is consistent with guidelines recommending that a cerebral perfusion pressure (MAP−ICP=CPP) of >60 mm Hg be maintained. (Journal of Neurotrauma 17 (6/7); p. 471, 2000) Practice Guideline

Intracranial Pressure Monitoring shown at reference 322:
This care is consistent with guidelines recommending that intracranial pressure monitoring should be undertaken in patients with an abnormal CT scan (contusions or hematomas, compressed basal cisterns, edema) or in patients with a normal scan who have two or more of the following: over the age of 40 years, have unilateral or bilateral motor posturing, systolic BP<90 mm Hg. (Journal of Neurotrauma 17 (6/7); p. 479, 2000) Practice Guideline

Ventricular Drainage shown at reference 324:
Ventricular drainage has been recommended when the ICP rises above normal (>20 mm Hg) as a first-line treatment. (Journal of Neurotrauma 17 (6/7); p. 538, 2000) Practice Option

Mannitol Administration shown at reference 326 in FIG. 3B:
This care is consistent with guidelines recommending Mannitol for management of increased intracranial pressure in severe traumatic brain injury in doses of 0.25-1 g/kg of body weight, as long as the serum osmolarity is less than 320 mOmsm/L. (Journal of Neurotrauma 17 (6/7); p. 521, 2000) Practice Guideline

Hyperventilation shown at reference 328:
This care is consistent with guidelines recommending that prolonged hyperventilation therapy—indicated by PCO2 of 25 mm Hg or less—be avoided in patients with severe traumatic brain injury who do not have increased intracranial pressure. (Journal of Neurotrauma 17 (6/7); p. 513, 2000) Practice Standard
This care is consistent with guidelines recommending that prophylactic hyperventilation (PCO2<35 mm Hg) be avoided in the first 24 hours after severe traumatic brain injury. (Journal of Neurotrauma 17 (6/7); p. 514, 2000) Practice Guideline

Barbiturates shown at reference 330:
It is recommended that high-does barbiturate therapy be considered when other forms of medical and surgical management have failed in controlling intracranial pressure in stable patients with severe traumatic brain injury. (Journal of Neurotrauma 17 (6/7); p. 527, 2000) Practice Option

Steroid Administration shown at reference 332:
Although steroid administration is not recommended for treatment of severe TBI, steroids may be used for non-TBI reasons

Anti-Convulsant Treatment shown at reference 334:
Prophylactic administration of anticonvulsants is recommended for the prevention of early post-traumatic seizures in patients with severe traumatic brain injury. (Journal of Neurotrauma 17 (6/7); p. 549, 2000) Practice Option

Nutritional Replacement shown at reference 336:
This care is consistent with recommended guidelines. Specific guidelines recommend that nutritional replacement achieve 140% of resting metabolism expenditure in non-paralyzed patients and 100% of resting metabolism in paralyzed patients using formulas containing a minimum of 15% of protein as calories by the seventh day following traumatic brain injury. (Journal of Neurotrauma 17 (6/7); p. 471, 2000) Practice Option

This exemplary report illustrates the type of information that can be provided to the caregiver 140 for a particular time period of treatment. See FIG. 1B.

The provision of evidence-based guidelines is significant both from a technical standpoint and from a psychological standpoint. In prior art systems, the medical professional/caregiver 140 would simply be told what she should or should not be doing and would be informed if a “wrong” action had been taken and usually at a time temporally distant from the clinical decision-making process, when changes in therapeutic maneuvers cannot be made. Not only would this then place the medical professional in a defensive position, but would also lead to a distrust of the system or at the very least a questioning of the system and its reliability to give the correct answer, particularly in circumstances that may introduce special issues or situations to consider.

One significant factor that the inventors have realized is that instead of providing the medical professional with an indication of whether treatment is “right” or “wrong” with the implied authority being the medical system, a much more favorable response is obtained in the evidentiary basis for recommendation is provided to the medical professional. In other words, rather than simply telling a medical professional what she should or should not be doing, an authoritative recommendation is provided, and the treatment by the medical professional is characterized as one that is “recommended by the guidelines” or “inconsistent with the guidelines” with the supporting basis for such a statement. This distinction is significant and not obvious in its effect. By providing the medical professional with an authoritative evidence-based source to support the guidelines, the system is much more likely to modify physician behavior to be in conformance with recommended guidelines, not only in a particular case at hand, but also in future cases as well, and thus serves as a valuable teaching tool. The process looks at the care continuously and brings the physician into compliance—therefore, this goes beyond the scope of mere assessment, training, and intervention. The feedback is given immediately and on every shift.

The patient's clinical condition and the care provided are followed in an interactive manner over the entire time in the hospital/institution 40 and monitored, ideally, at least once a shift, documenting change in care as feedback is received.

The interactive process continues for the entire time the patient is in the ICU—typically ten to fifteen days. This information is instantly analyzed and assessed utilizing various algorithms and parametric comparisons, generating a customized report for the patient. This unique and sophisticated process constitutes one of the unique features. The term “evidence based medicine” is utilized in known services, and some of these services may access evidence-based guidelines via the Internet, but the system, as described above, provides for an exchange of information in a frequent periodical manner (ideally, every hospital shift), via real time interactivity, a report to physicians evaluating the specific level of compliance with guidelines for each patient.

This system is therefore uniquely positioned to provide hospitals with ongoing, customized reports that indicate how care in trauma hospitals moves toward compliance with evidence-based treatment guidelines. The health departments 146 and hospital personnel 140 receive customized reports from the system.

Each participating hospital should have access to 24/7 support from support personnel. Support can include technical assistance with the system and software, with inputting of patient data, and with the patient compliance report. In addition, specific medical questions will be answered by an employed neurosurgeon and fully knowledgeable with treatment guideline implementation and outlier issues with patients.

Each participating hospital will be given site-specific educational training led by knowledgeable medical personnel and supported by nationally recognized medical professionals who are leaders in the implementation of evidence-based medicine. This can ensure the thorough understanding of product functionality and the effective use of reports. This is a highly unique training program with continuing education conducted for the hospitals' caregivers as needed in the future.

The method and system provide independent third-party documentation of compliant care that may be added to each patient's chart, thereby providing physicians and hospitals with a new and unique level of significant liability protection.

The system monitors, through its medical department, publication of evidence-based recommendations, and modifies its software program accordingly. As new recommendations are available, hospital personnel are advised of changes in specific recommendations and/or quality of evidence supporting current recommendations.

This ongoing level of service for physicians and hospitals, which provides the latest recommended treatment information, and delivers it to the point of patient care in the ICU, is a valuable service provided to physicians and/or hospitals.

In sum, the system provides quality assessment in that it assesses compliance with evidence-based recommendations for patient care approved by national subspecialty organizations. It provides quality assurance in that, after assessing patient care compliance, a feedback form in hard copy provides an intervention in which care givers are apprised of their current treatment vis à vis national recommendations. It provides an ongoing record of physician behavior modification in that the patient clinical condition and care provided is followed over an entire ICU stay or other admission, and monitored regularly, showing change in care as feedback is received where non-compliance exists.

It further provides liability protection because once patient care becomes compliant, a written form is available for the patient chart, thereby documenting non-vested interest, third-party assessment of compliance. The system provides overall reports of hospital compliance with recommendations in that a supporting agency (e.g., state government, hospital, insurance carrier) is able to receive customized reports of overall compliance within the care setting, thereby documenting evidence-based care delivery.

By implementing the software with a secure system, such as secure web-based interactions, patient data privacy and confidentiality can be preserved. In order to ensure a highly secure HIPAA-compliant environment, the program and medical records may reside on a server in secure data vault characterized by many levels of protected access, with encryption levels meeting the highest known and recognized standards.

Specialist-delivered educational programs can be provided by, e.g., each participating center being given site-specific educational programs led by system medical personnel that ensure complete understanding and facility with program functionality. 24/7 technical and education support may be provided, where each participant receives a number to call which will put them in immediate touch with support personnel for program and software use.

The system data and software may be automatically updated as recommendations change or are added. The system can monitor publication of evidence-based recommendations, and modify its software and data accordingly. Ongoing educational programs may be used to inform users of changes in recommendations. As new recommendations are available, hospital personnel can be advised of changes in specific recommendations and/or quality of evidence supporting current recommendations.

The system or systems may be implemented on any general purpose computer or computers and the components may be implemented as dedicated applications or in client-server architectures, including a web-based architecture. Any of the computers may comprise a processor, a memory for storing program data and executing it, a permanent storage such as a disk drive, a communications port for handling communications with external devices, and user interface devices, including a display, keyboard, mouse, etc. When software modules are involved, these software modules may be stored as program instructions executable on the processor on media such as tape, CD-ROM, etc., where this media can be read by the computer, stored in the memory, and executed by the processor.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The word mechanism is used broadly and is not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A method for providing continuous patient care, comprising repeated steps of:
entering guidelines and associated parameters in an evidence-based guidelines database that comprises guidelines, treatment recommendations, and guideline source of origin information;
entering, by a caregiver on a caregiver device at a caregiver facility, patient status and treatment information on a periodic basis;
securely transmitting the entered patient information to a secure assessment system;
immediately after receipt of the patient information by the secure assessment system, performing the following by the secure assessment system:
retrieving relevant guidelines from the guidelines database;
comparing the retrieved guidelines with the patient information using a parametric comparison;
generating a patient customized assessment report by the secure assessment system that includes an assessment of the patient treatment information; and
securely transmitting the patient customized assessment report to the caregiver.

2. The method according to claim 1, further comprising the steps of:
analyzing peer-reviewed published guidelines;
converting the analyzed peer-reviewed published guidelines into the entered guidelines and associated parameters;
providing, with a guideline, a source of information and a quality assessment of the source of information; and
including the quality assessment in the patient customized assessment report.

3. The method according to claim 1, further comprising:
updating an old guideline in the guidelines database with a new guideline;
identifying changes between the old guideline and the new guideline;
including the identified changes in at least one of the patient customized assessment report and a separate guideline change report.

4. The method according to claim 1, wherein the assessment of the patient treatment information includes an assessment relative to the guidelines and does not include an assessment of the caregiver's performance.

5. The method according to claim 1, wherein a period of the periodic basis is a shift of a caregiver facility.

6. The method according to claim 1, further comprising:
contacting, by the caregiver, a technical or medical support staff and
receiving a respective technical or medical response therefrom.

7. The method according to claim 1, further comprising:
storing the patient information;
generating a summary report based on cumulative stored patient information;
securely transmitting the summary report to at least one of a state government, a hospital, a caregiver administrative department, and an insurance carrier.

8. The method according to claim 1, wherein steps of the method utilize a client-server architecture, the caregiver device being a client of the client-server architecture and the assessment system being a server of the client-server architecture.

9. The method according to claim 8, wherein the client-server architecture is a web-based architecture.

10. The method according to claim 1, wherein the caregiver facility is an intensive care unit, and the patient is a patient with severe traumatic brain injury.

11. The method according to claim 1, wherein the steps are repeated during the patient's entire stay at the caregiver facility or other admission.

12. The method according to claim 1, wherein the secure transmission utilizes at least one of wireless technology, broadband technology, and telephone technology.

13. The method according to claim 1, wherein the secure assessment system is remotely located from the caregiver facility.

14. The method according to claim 1, wherein access to the secure assessment system utilizes at least one of a fire wall, an access card, biometric identification, a server password, and encryption.

15. A system for providing continuous patient care, comprising:
an evidence-based guidelines database that comprises guidelines, treatment recommendations, and guideline source of origin information;
a caregiver device via which a caregiver enters patient status and treatment information on a periodic basis, the caregiver device comprising a secure communications link; and
an assessment system comprising a secure communications link that securely receives data that includes the patient status and treatment information from the caregiver device communications link, the assessment system having a communications link to the evidence-based guidelines database via which guidelines are accessed and then compared to the patient status and treatment information using a parametric comparison, the assessment system having a report generator that generates a patient customized assessment report, the assessment system transmitting the report over the secure communications link to the caregiver device.
